(19) United States
(12) Patent Application Publication
(10) Pub. No.: US 2015/0235163 A1
(43) Pub. Date: Aug. 20, 2015

(54) TRACKING SYSTEM

(71) Applicant: Amit Gupta, Mumbai (IN)

(72) Inventor: Amit Gupta, Mumbai (IN)

(21) Appl. No.: 14/626,933

(22) Filed: Feb. 20, 2015

(30) Foreign Application Priority Data
Feb. 20, 2014 (IN) 595/MUM/2014

(51) Int. Cl. G06Q 10/06; G06F 17/30

(52) U.S. Cl. CPC G06Q 10/063114; G06F 17/30368; G06F 17/30864

(57) ABSTRACT

A method and system for tracking an absconding employee is disclosed. The system includes a database maintaining one or more employee profiles, an interface module to receive a request to track an absconding employee, the interface module to initiate at least one communication with the absconding employee using at least one request detail and an analytical module to take a preliminary action for the received request and pursue at least one settlement option based upon a response to the at least one communication.

The present application is based on, and claims priority from, Indian Complete Application number 595/MUM/2014 filed on 20 Feb. 2014, the disclosure of which is hereby incorporated by reference herein.

### TECHNICAL FIELD

Embodiments herein relate to a tracking system, specifically, relates to a system and method for tracking absconding employees.

### BACKGROUND

Technology has marked its presence in almost all walks of life including, functioning of an organization. An organization caters to a number of internal functions relating to, for example, accounts, human resource, information technology support, etc. With reference to human resource, the functions include, conducting recruitments and/or trainings, maintaining employee records, performing employee assessment, etc. In each of these cases, technology has been deployed to achieve the desired result with precision. However, a human resource function which still lacks technology support, is availability of information on absconding employees.

Currently, if an employee absconds without informing concerned people in a company, it may not be possible to track the employee. The company may not have a platform to track the absconding employee. At best, the company may reach out to the employee a number of times, failing which, the company may report the employee as absconding within its internal system. It may be very fatal to the company as the employee may be privy to insider information or it may be time consuming to find a replacement with same skill-set and/or experience level or the employee may not have fulfilled contractual obligations.

In addition, another organization that may hire an absconding employee, may have no means to track absconding employees' data online/offline before recruiting the absconding employee. The absconders' data may remain private and not available to other organizations to make hiring decisions or know about employee trends. Further, an absconder may leave one place within a very short period and join another place and report that period as ideal time thereby, creating an impression that they never absconded from a particular organization. Absconding employees thus put the organization in jeopardy by leaving them suddenly, leaving a gaping hole, taking away confidential information, creating a bad environment and not taking responsibility for any of their acts.

Therefore, there is a need for a system that obviates the above drawbacks and provides a system and method for tracking absconding employees.

### SUMMARY

The following summary is provided to facilitate an understanding of some of the innovative features unique to the disclosed embodiments and is not intended to be a full description. A full appreciation of the various aspects of the embodiments disclosed herein can be gained by taking into consideration the entire specification, claims, drawings, and abstract as a whole.

A method for tracking an absconding employee is disclosed. The method includes maintaining one or more employee profiles in a database, receiving a request through an interface module to track the absconding employee, taking a preliminary action for the received request using an analytical module, initiating at least one communication with the absconding employee via the interface module using at least one request detail and pursuing at least one settlement option proposed by the analytical module based upon a response to the at least one communication.

A system for tracking an absconding employee is disclosed. The system includes a database maintaining one or more employee profiles, an interface module to receive a request to search/track an absconding employee, the interface module to initiate at least one communication with the absconding employee using at least one request detail and an analytical module to take a preliminary action for the received request and pursue at least one settlement option based upon a response to the at least one communication.

Other aspects and advantages will become apparent from the following detailed description, taken in conjunction with the accompanying drawings, illustrating by way of examples.

### BRIEF DESCRIPTION OF THE DRAWINGS

FIG. 1 is a schematic diagram of a system according to one embodiment herein.

FIG. 2 is a schematic diagram of a tracking system according to one embodiment herein.

FIG. 3 is flow diagram illustrating a number of steps carried out by a server of the tracking system in FIG. 1.

FIG. 4 depicts an exemplary flowchart illustrating search procedure for an absconding employee.

### DETAILED DESCRIPTION OF PREFERRED EMBODIMENTS

Web-based/application programming interface (API) based/mobile application based methods and systems for tracking absconding employees are disclosed. The following description is presented to enable any person skilled in the art to make and use embodiments as disclosed herein. For purposes of explanation, specific nomenclature is set forth to provide a thorough understanding of the present embodiments. Descriptions of specific applications are provided only as examples. Various modifications to the preferred embodiments will be readily apparent to those skilled in the art, and the general principles defined herein may be applied to other embodiments and applications without departing from the spirit and scope of the embodiments as disclosed herein. Thus, the present embodiments are not intended to be limited to the embodiments shown, but are to be accorded the widest scope consistent with the principles and features disclosed herein.

Applications, software programs or computer readable instructions may be referred to as components or modules. Applications may be hardwired or hard coded in hardware or take the form of software executing on a general purpose computer such that when the software is loaded into and/or executed by the computer, the computer becomes an apparatus for practicing the embodiments as disclosed herein, or they are available via a web service. Applications may also be downloaded in whole or in part through the use of a software development kit or a toolkit that enables the creation and implementation of the present embodiments. In this specification, these implementations, or any other form that the embodiments may take, may be referred to as techniques. In general, the order of the steps of disclosed processes may be altered within the scope of the embodiments as disclosed herein.

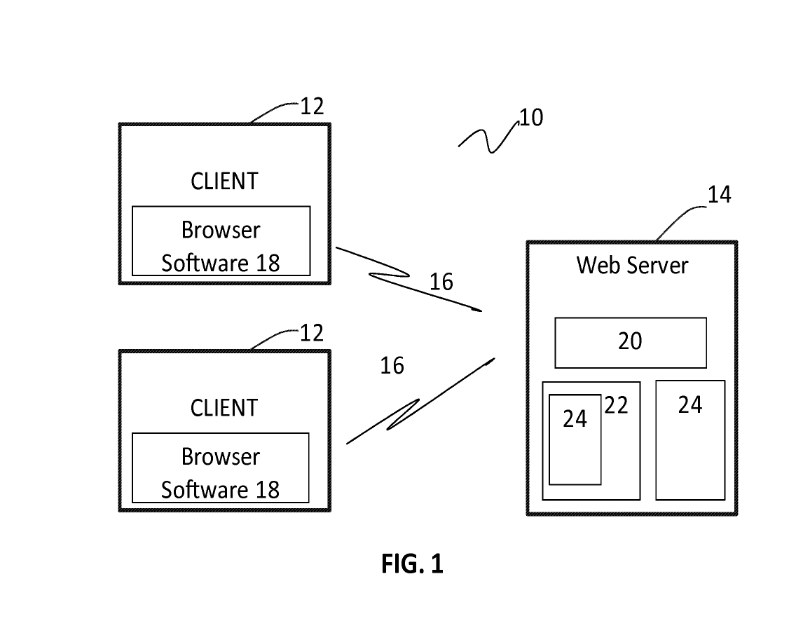

Referring now to the drawings, FIG. 1 is an example of a distributed system 10 configured as client/server architecture used in an embodiment herein. A “client” is a member of a class or group that uses the services of another class or group to which it is not related. In the context of a computer network, such as the Internet, a client is a process (i.e. roughly a program or task) that requests a service which is provided by another process, known as a server program. The client process uses the requested service without having to know any working details about the server program or the server itself. In networked systems, a client process usually runs on a computer that accesses shared network resources provided by another computer running a corresponding server process. However, it should also be noted that it is possible for the client process and the server process to run on the same computer.

A “server” is typically a remote computer system that is accessible over a communications medium such as the Internet. The client process may be active on a second computer system, and communicate with the server process over a communications medium that allows multiple clients to take advantage of the information-gathering capabilities of the server. Thus, the server essentially acts as an information provider for a computer network.

The block diagram of FIG. 1 shows a distributed system 10 that includes a plurality of client computers 12 and a web server 14 which are connected to a network 16. The network 16 will be hereinafter generally referred to as the Internet. Although the system and method disclosed herein is specifically useful for the Internet, it should be understood that the client computers 12 and web server 14 may be connected together through one of a number of different types of networks. Such networks may include local area networks (LANs), other wide area networks (WANs), and regional networks accessed over telephone lines, such as commercial information services. The client and server processes may even comprise different programs executing simultaneously on a single computer.

The client computers 12 can be conventional personal computers (PCs), workstations, mobile phones, smartphones, or computer systems of any other size. Each client computer 12 may include one or more processors, memories, input/output devices, and a network interface, such as a conventional modem, a wireless receiver, etc. The web server 14 can be similarly configured.

A display on the client computer 12 enables a user to interact with for example, a web application, a web page, etc via a user interface displayed on the computer 12. For purposes of the preferred embodiment, it is assumed that the display is used to present information to each user, but it should be understood that information may be presented to a user by an audio signal, a Braille interface or any other suitable user interface.

The client computers 12 can execute web browser programs 18, such as the NAVIGATOR, EXPLORER, or FIREFOX browser programs, to locate the web pages or data stored on the web server 14. The browser programs 18 allow the users to enter addresses of specific web pages to be retrieved. These addresses are referred to as Uniform Resource Locators, or URLs. In addition, once a page has been retrieved, the browser programs 18 can provide access to other pages or records when the user “clicks” on hyperlinks or other elements on a web page. Such hyperlinks/elements are located within a web page and provide an automated way for the user to enter the URL of another page and to retrieve that page. The pages can be data records including plain textual information, or more complex digitally encoded multimedia content, such as software programs, graphics, audio signals, videos, and so forth.

In an embodiment, shown in FIG. 1, client computers 12 communicate through the network 16 with various network information providers, including web server 14 using the functionality provided by a HyperText Transfer Protocol (HTTP), although other communications protocols, such as File Transfer Protocol (FTP), Simple Network Management Protocol (SNMP), TELNET, and a number of other protocols known in the art, may be used. The client computers 12 may be used by different types of users, for example, a client computer 12 may be used by an organization or entity or individual to provide information about one or more absconding employees to be uploaded on the web server 14. Alternately, a client computer 12 may be used by an organization/entity/individual who may wish to search history of an employee before hiring to ascertain that the employee does not have absconding history.

The web server 14 hosts a website of an individual/entity and is located on the World Wide Web. The web server 14 includes a tracking system 20, a computer storage medium 22 and a processing system 24. A database 26 is stored on the storage medium 22 of the web server 14. The database 26 contains data relating to one or more web pages, one or more absconding employees, one or more organizations, and a variety of information, described below. It will be appreciated from the description below that the system and method of the present disclosure may be implemented in software that is stored as executable instructions on a computer storage medium, such as memories or mass storage devices, on the web server 14. Conventional browser programs 18, running on client computers 12, may be used to access information stored on the web server 14. In an embodiment, access to the web server 14 is accomplished through a firewall, not shown, which protects stored data from external tampering. Additional security may be provided via enhancements to the standard communications protocols such as Secure HTTP or the Secure Sockets Layer. Alternately, information stored on the web server 14 can be accessed by either API based access system, via mobile application or via an employee historical timeline profile.

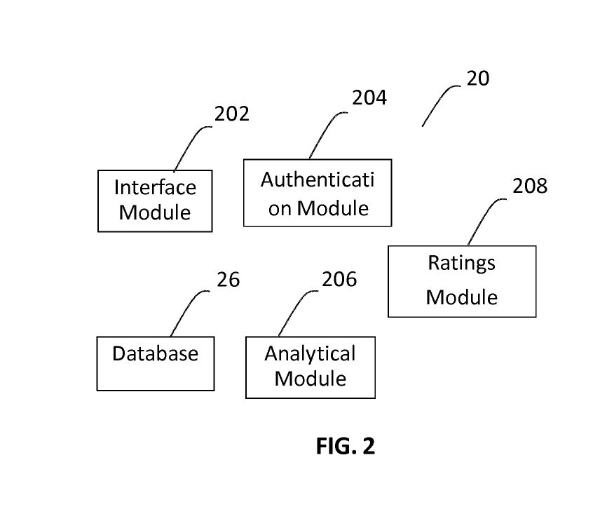

A web server 14 may refer to the web server of an entity/individual providing services/products for tracking an absconding employee. The modules (described in FIG. 2) of the tracking system 20 on the web server 14 perform various functions without limitation, taking a preliminary action, initiating at least one communication, pursuing at least one settlement option, etc to track an absconding employee.

In an embodiment, the tracking system 20 may be hosted on a cloud and may serve as a central repository for companies to access and take informed decision. In an embodiment, whenever any employee is being hired by an organization, the employee record is checked using the database 26.

FIG. 2 illustrates an exemplary block diagram of the tracking system 20. The web server 14 includes a database 26, an interface module 202, an authentication module 204, an analytical module 206, and a ratings module 208. As stated above, the web server 14 is connected to the network 16, for example, Internet via which it can be accessed by one or more client computers 12.

The database 26 stores data of one or more employees who have been declared absconded by their respective organizations and/or details of a requester. The requester may be an organization or an entity or an individual. The data includes without limitation, name of the employee, data associated with an employee which is unique to the employee and/or specific to a country, specialization, organization name(s) where the employee has worked, contact details, etc. The uploaded data may have multiple layers of encryption, for example, four layers, using varying complex algorithms. The four layers may pertain to:

Layer 1: Personal unique data

Layer 2: Professional data visible only to organization

Layer 3: Professional data visible to other organizations

Layer 4: Professional data visible to system subscribers

In addition, the database 26 stores all communications between an employee, organization and the web server.

The interface module 202 is configured to receive a request from the client computers 12. For example, a client computer may send a request to provide information about an absconding employee or to search for an absconding employee in the available data. In an embodiment, the request may be received by the interface module 202 as a form with absconding employee information including pan number, passport number, birth date, etc. Additionally, the interface module 202 is configured to respond to the received request by transmitting data, for example, web page data, application data, information packets containing a communication, etc to a requesting client computer 12. In addition, the interface module 202 may send at least one communication to an absconding employee using one or more contact details stored in the database 26 or received in the request. Exemplary instances include sending an email to an absconding employee, triggering a voice call using an interactive voice response, crawling the at least one social media profile of the absconding employee, etc.

The authentication module 204 is an optional module and may be included in an embodiment where access to the tracking system is subscription based, for example, with an annual subscription fee and/or a settlement fee. If present, the authentication module 204 verifies if a user who has logged in to the tracking system, is a subscriber or not and the type of rights the user has with respect to the system. For example, the authentication module 204 may select a unique alphanumeric value and direct the interface module 202 to send the same to a registered email address of a user logging in to the tracking system. Also, the authentication module 204 may direct the interface module 202 to forward a unique link after receiving user credentials. When the link is accessed, one or more questions may be posed to the user to be answered correctly to allow logging in. In an embodiment, the unique alphanumeric value is used to form an audit trail.

The analytical module 206 analyzes each received request and takes a preliminary action for each received request. For example, the analytical module 206 performs a look-up/search in the database 26 to determine if such employee's name is present in the database 26 or to create a new entry. Alternately, on successful creation of a new record, an alert and/or other contact details to an associated email ID or to a user who has performed earlier searches, is sent. The analytical module 206 also pursues one or more settlement options based upon a response to the communication initiated by the interface module 202. The settlement options include without limitation, negotiating with an absconding employee to pay an outstanding amount, negotiating with an absconding employee to resume communication with a concerned employer, informing an organization the unlikelihood of the absconding employee to return if no response to the communication is received, file a dispute, etc. For example, in case an absconding employee's response voices concerns, the analytical module 206 may alert the respective organization to reengineer the past and the organization may respond to all employee actions. As per another example, an absconding employee can log in to the tracking system 20 and initiate a communication with the human resource (HR) team of the respective organization on settlement process, file a dispute or pay the settlement amount. Such communications may be automated or manual.

Alternatively, the analytical module 206 may trigger searches through one or more social media networks using employee data to find out the latest contact or employment details. The analytical module 206 may direct the interface module 202 to send an email or text to the registered contact details of such employee to initiate a communication with the employee as described above. For example, the analytical module 206 pushes out alerts via one or more of email or text to all employee contact details entered by ex-employer and/or found from social networks or all historical email addresses entered for that login. Further, in case there is successful settlement between an absconding employee and an organization, the analytical module 206 may ‘auto-delete’ or ‘trigger-delete’ or ‘manual-delete’ the name of the absconding employee from the one or more profiles of the absconding employees stored in the database 26.

The ratings module 208 rates every employee whose name is present in the database 26. In an embodiment, the rating may pertain to the likelihood or unlikelihood of an absconding employee to join the respective organization. The criteria for such assessment includes without limitation time period within which an employee reverts, whether the response is positive or negative, etc. An employee rating is dependent upon an automated scoring system enabled by several factors including without limitation, employee behavior (including absconding from any employment and it being reported), employment duration (e.g. minimum 1.5-3 years employment basis type of position), qualification (verified rating for professional and educational), etc. The ranking score may vary from 1-100, 1-10 or likewise formations etc.

It is possible to merge or unmerge functionality of various modules in a single or multiple modules described above and such variations are within the scope of the present disclosure. Further, the processing system 24 of FIG. 1 may execute the functions of various modules described above.

Optionally and in addition to the above modules, the tracking system 20 may include one or more of a query module, an organization structure module, a peer-to-peer organization connection module and a security module. The query module may help in querying the database 26 on various parameters stored therein to obtain the corresponding data. The organization structure module may define the access matrix of people within an organization and enable maker-checker functionality. Such information may be helpful when an absconding employee wishes to get in touch with the respective organization again. The peer-to-peer organization connection module may help in connecting and collaborating between member organizations and facilitate informed decision making about an absconding employee. The security module may assist in keeping check on data access layer and overall secure data flow across system.

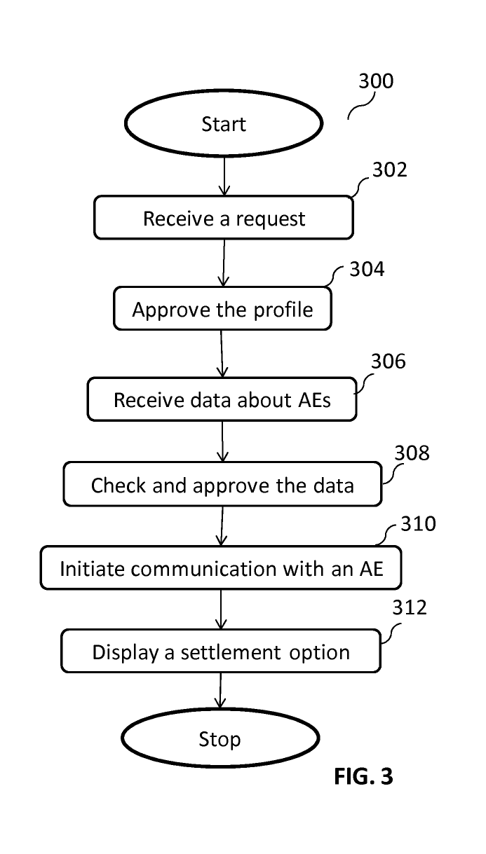

FIG. 3 depicts an exemplary flowchart 300 detailing registration of an entity with the tracking system. At step 302, the tracking system 20 hosted on the web server 14 receives a request from an organization like a company, partnership firm or any entity to register with the tracking system. The organization may register to provide information about absconding employees and/or search for one or more absconding employees. The request may be received by way of an email, a voice note, a phone call, etc. The organization may be required to create a profile in the tracking system 20. The profile creation may entail defining system touch points, make-checker roles, setting up additional security layer, etc. Once the profile is created, the organization may be approved at step 304. The profile may be approved by way of for example, signing a physical contract, generating an alphanumeric code and/or a verification link to the registered email address of the organization for confirmation.

At step 306, the tracking system receives data about one or more absconding employees (AEs) of the organization and stores the same in the database. In an embodiment, the data may be encrypted before being stored in the database using symmetric/asymmetric encryption techniques. The data stored in the database may be checked and approved so that it can be used for subsequent searches at step 308.

At step 310, the tracking system initiates one or more communications with the absconding employee. For example, the tracking system may send an email to one or more email addresses of the absconding employee. Alternately or in combination, the tracking system may initiate a voice call or text message for the absconding employee using the contact number obtained in the request or database. In addition, login details to the tracking system may be provided to the absconding employee to take further action like settle, write to HR, negotiate, etc.

At step 312, depending upon the response of the absconding employee, relevant one or more settlement options may be displayed to the organization. For example, if the absconding employee responds for cash settlement, the organization will be provided an option to provide dues that the absconding employee needs to clear.

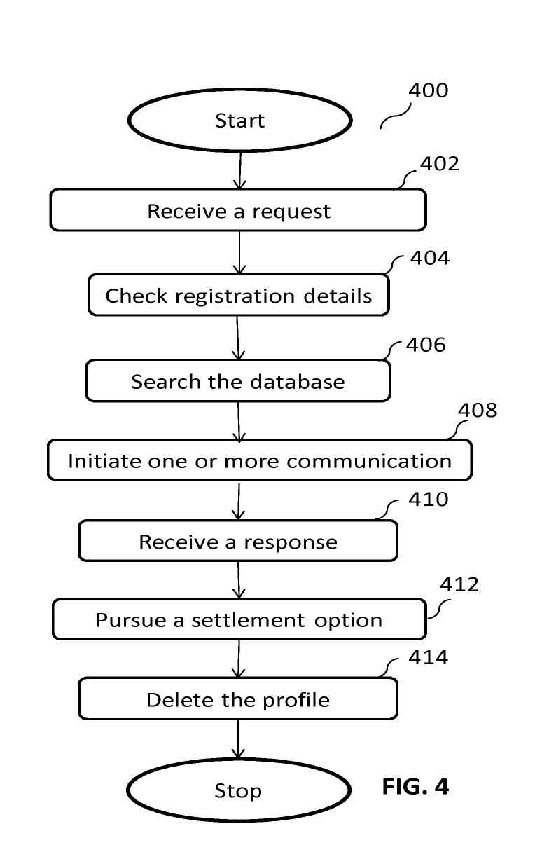

FIG. 4 depicts an exemplary flowchart 400 illustrating search for an absconding employee. At step 402, the tracking system 20 hosted on the web server 14 receives a request from an organization like a company, partnership firm or any entity wishing to track/search an absconding employee. The request may be received by way of an email, a voice note, a phone call, etc. An optional step before continuing with the tracking process includes checking if the request is received from a registered/subscribed user at step 404. If not, the organization may be directed to registration steps 302 and 304 of FIG. 3.

At step 406, the tracking system searches the database to ascertain if details of the absconding employee are present. The tracking system obtains the details of the absconding employee from the request and utilizes the same for its searches. In an embodiment, during a search, the name of the absconding employee received with the request may be compared with the names of the profiles stored in the database. In case any results are obtained from the search, the results may be forwarded/displayed to the requesting organization. Also, if the name of the organization mentioned in the database record is different from the name of the requesting organization, then upon checking of certain parameters, the name of the requesting organization may be added to the absconding employees' profile. Such parameters include birth details, academic details, etc. In case the name is absent, the details of such absconding employee may be added to the database.

At step 408, the tracking system initiates one or more communications with the absconding employee. For example, the tracking system may send an email to one or more email addresses of the absconding employee. Alternately or in combination, the tracking system may initiate a voice call with the absconding employee using the contact number obtained in the request or database. Yet alternately or in combination, the tracking system may crawl one or more feeds or social media web pages of the absconding employee to gather information on latest activity at the employee's end. In an embodiment, encouraging communication may be sent to the absconding employee to increase the probability of the absconding employee to respond. In case the tracking system receives a response from the absconding employee, the method proceeds to step 410, else, the method stalls at this step till further activity by absconding employee or the organization.

At step 410, the tracking system receives a response from the absconding employee. The tracking system analyzes the response to ascertain whether the employee is interested in settlement and pursues at least one settlement option accordingly at step 412. The settlement options include without limitation filing a dispute with the tracking system, negotiating with/from the absconding employee to pay an outstanding amount, negotiating with/from the absconding employee to resume communication with a concerned employer and/or informing an organization the unlikelihood of the absconding employee to return if no response to the at least one communication is received.

At step 414, the profile of the absconding employee is deleted from the database if the absconding employee and the requesting organization reach an amicable solution for example, paying of settlement fee, commencing work, etc.

It should be noted that the teachings of the present disclosure can be applied individually or features of various embodiments described above may be combined together. Such variations are within the scope and spirit of the present disclosure. In an embodiment, the tracking system 20 generates one or more alerts to be sent to a current email, historical contact changes and organization responsibility matrix stakeholders. In addition, the tracking system 20 helps in increasing employee's productivity and hiring efficiency of the industry or an organization. It also reduces human resource (HR) losses with respect to talent/intellectual property loss, and the risk of hiring employees with absconding track record/who are absconding in other organizations. Optionally, the tracking system may provide data usage reports to an organization which the organization can view to modify their employee policies, etc.

It will be appreciated that variations of the above disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

We claim,

1) A method for tracking an absconding employee, said method comprising:
a. maintaining one or more employee profiles in a database;
b. receiving a request through an interface module to report/track/search the absconding employee;
c. taking a preliminary action for the received request using an analytical module;
d. initiating to at least one communication with the absconding employee via the interface module using at least one request detail; and
e. pursuing at least one settlement option proposed by the analytical module based upon a response to the at least one communication.

2) The method of claim 1 further comprising encrypting the one or more employee profiles and storing the encrypted employee profiles in the database.

3) The method of claim 1 further comprising authenticating the request.

4) The method of claim 1 further comprising rating the likelihood of the return of the absconding employee.

5) The method of claim 1 further comprising deleting the profile of the absconding employee on successfully pursuing the at least one settlement option.

6) The method of claim 1 further comprising updating a record of the absconding employee if the name of a last worked organization in the database is different from a requesting organization name.

7) The method of claim 1 wherein the taking the preliminary action comprises searching a profile of the absconding employee in the database.

8) The method of claim 7 further comprising creating the profile of the absconding employee if the profile is not found.

9) The method of claim 1 wherein the initiating the at least one communication comprises sending an email/text to the absconding employee, triggering a voice call using an interactive voice response and/or crawling at least one social media profile of the absconding employee.

10) The method of claim 1 wherein the pursuing the at least one settlement option comprises negotiating with the absconding employee to pay an outstanding amount, negotiating with the absconding employee to resume communication with a respective employer, filing a dispute and/or informing an organization the unlikelihood of the absconding employee to return if no response to the at least one communication is received.

11) The method of claim 1 wherein the one or more employee profile comprises an employee name, unique identity details, at least one employee contact detail, and employee work history.

12) An absconding employee tracking system, said system comprising:
a. a database maintaining one or more employee profiles;
b. an interface module to receive a request to track an absconding employee, the interface module to initiate at least one communication with the absconding employee using at least one request detail; and
c. an analytical module to take a preliminary action for the received request and pursue at least one settlement option based upon a response to the at least one communication.

13) The system of claim 12 wherein the database stores the one or more encrypted employee profiles.

14) The system of claim 12 wherein the interface module is configured to send an email to the absconding employee, trigger a voice call/text message using an interactive voice response and/or crawl at least one social media profile of the absconding employee.

15) The system of claim 12 wherein the analytical module is configured to search a profile of the absconding employee in the database and/or create the profile of the absconding employee if the profile is not found in the search.

16) The system of claim 12 wherein the analytical module is configured to negotiate with the absconding employee to pay an outstanding amount, negotiate with the absconding employee to resume communication with a concerned employer, file a dispute and/or inform an organization the unlikelihood of the absconding employee to return if no response to the at least one communication is received.

17) The system of claim 12 wherein the one or more employee profile comprises an employee name, at least one employee contact detail, and employee work history.
